(19) United States
(12) Patent Application Publication
(10) Pub. No.: US 2008/0258478 A1
(43) Pub. Date: Oct. 23, 2008

(54) Security Device Having A Cable

(76) Inventors: Pedro Lopez, Pompano Beach, FL (US); Franklin H. Valade, Fort Walton Beach, FL (US); Robert L. Michael, Margate, FL (US); Gilbert Fernandez, Weston, FL (US)

Correspondence Address: IP LEGAL DEPARTMENT;TYCO FIRE & SECURITY SERVICES, ONE TOWN CENTER ROAD, BOCA RATON, FL, 33486, US

(21) Appl. No.: 11/792,623

(22) PCT Filed: Dec. 7, 2005
(86) PCT No.: PCT/US05/44690

§ 371 Date: Jun. 30, 2008

Related U.S. Application Data
(60) Provisional application No. 60/683,657, filed on May 23, 2005.
(60) Provisional application No. 60/633,813, filed on Dec. 7, 2004.

(51) Int. Cl. E05C 19/16

(52) U.S. Cl. 292/251.5; 70/57.1

(57) ABSTRACT

Systems and apparatuses for a security device having a cable (922) are disclosed.

This application claims priority to the U.S. Provisional Patent Application Ser. No. 60/633,813 titled “Improved EAS Security Tags” filed Dec. 7, 2004, and to the U.S. Provisional Patent Application Ser. No. 60/683,657 titled “Improved EAS Security Tags” filed May 23, 2005, both of which are incorporated herein by reference in their entirety.

### RELATED APPLICATIONS

This international application designating the United States of America is related to the following applications designating the United States of America:
(1) “Magnetically Actuable Locking Mechanism And Associated Security Device”;
(2) “Optical Disc Security Device Having A Magnetically Actuable Locking Mechanism”;
(3) “Security Device For An Article Having A Constrained Elongate Element”; and
(4) “Security Device For A Bottle.”

These related applications are being filed concurrently herewith and are incorporated by reference in their entirety.

### BACKGROUND

A security tag system is designed to prevent unauthorized removal of an item from a controlled area. For example, a typical Electronic Article Surveillance (EAS) system may comprise a monitoring system and one or more security tags. The monitoring system may create a surveillance zone at an access point for the controlled area. A security tag may be enclosed in a security device that is secured to the monitored item, such as an article of hard goods, e.g., sporting equipment, eye wear, jewelry, bottles, and the like. If the monitored item enters the surveillance zone, an alarm may be triggered to indicate unauthorized removal.

The security device may be secured to a number of different items. It may be desirable for the security device to allow authorized release from the article, while making unauthorized release relatively difficult. Consequently, there may be a need for improved techniques in security devices in general, and systems for securing the security devices to articles in particular.

### BRIEF DESCRIPTION OF THE DRAWINGS

The subject matter regarded as embodiments is particularly pointed out and distinctly claimed in the concluding portion of the specification. Embodiments, however, both as to organization and method of operation, may best be understood by reference to the following detailed description when read with the accompanying drawings in which:

FIG. 1 illustrates components of a security device and system, in accordance with one embodiment;

FIG. 1A illustrates a perspective view of a detacher, in accordance with one embodiment;

FIG. 1B illustrates a top view of a detacher, in accordance with one embodiment;

FIG. 1C illustrates a front view of a detacher, in accordance with one embodiment;

FIG. 1D illustrates a side view of a detacher, in accordance with one embodiment;

FIG. 1E illustrates a perspective view of a portion of a security device configured for one-time use;

FIG. 1F illustrates a top view of portion of a security device configured for one-time use;

FIG. 1G illustrates a perspective view of a portion of a security device configured to be resettable;

FIG. 1H illustrates a perspective view of a portion of a security device configured for one-time use;

FIG. 1I illustrates a top view of a portion of a security device configured for one-time use;

FIG. 1J illustrates a front view of a portion of a security device configured for one-time use;

FIG. 2 illustrates a perspective view of a cabled security device, in accordance with one embodiment;

FIG. 3 illustrates a perspective view of a portion of a cabled security device with a top housing removed, in accordance with one embodiment;

FIG. 4 illustrates an exploded view of a cabled security device, in accordance with one embodiment;

FIG. 5 illustrates a perspective view of a cabled security device, in accordance with one embodiment;

FIG. 6 illustrates a partially internal top view of a cabled security device, in accordance with one embodiment;

FIG. 7 illustrates a front view of a cabled security device, in accordance with one embodiment;

FIG. 8 illustrates a side view of a cabled security device, in accordance with one embodiment;

FIG. 9 illustrates a side view of a cabled security device, in accordance with one embodiment;

FIG. 10 illustrates a perspective view of a security tag assembly, in accordance with one embodiment;

FIG. 11 illustrates a perspective view of a security tag assembly, in accordance with one embodiment;

FIG. 12 illustrates a perspective view of a security tag assembly, in accordance with one embodiment;

FIG. 13 illustrates a perspective view of a security tag assembly, in accordance with one embodiment;

FIG. 14 illustrates a perspective view of a cabled security device, in accordance with one embodiment;

FIG. 15 illustrates a perspective view of a portion of a cabled security device with a top housing removed, in accordance with one embodiment;

FIG. 16 illustrates an exploded view of a cabled security device, in accordance with one embodiment;

FIG. 17 illustrates a perspective view of a cabled security device, in accordance with one embodiment;

FIG. 18 illustrates a partially internal top view of a cabled security device, in accordance with one embodiment;

FIG. 19 illustrates a front view of a cabled security device, in accordance with one embodiment;

FIG. 20 illustrates a side view of a cabled security device, in accordance with one embodiment;

FIG. 21 illustrates a side view of a cabled security device, in accordance with one embodiment;

FIG. 22 illustrates a perspective view of a cabled security device, in accordance with one embodiment;

FIG. 23 illustrates a perspective view of a portion of a cabled security device with a top housing removed, in accordance with one embodiment;

FIG. 24 illustrates an exploded view of a cabled security device, in accordance with one embodiment;

FIG. 25 illustrates a perspective view of a cabled security device, in accordance with one embodiment;

FIG. 26 illustrates a partially internal top view of a cabled security device, in accordance with one embodiment;

FIG. 27 illustrates a front view of a cabled security device, in accordance with one embodiment;

FIG. 28 illustrates a side view of a cabled security device, in accordance with one embodiment;

FIG. 29 illustrates a side view of a cabled security device, in accordance with one embodiment;

FIG. 30 illustrates a perspective view of a cabled security device, in accordance with one embodiment;

FIG. 31 illustrates a perspective view of a cabled security device, in accordance with one embodiment;

FIG. 32 illustrates a perspective view of a cabled security device, in accordance with one embodiment;

FIG. 33 illustrates a perspective view of a cabled security device, in accordance with one embodiment;

FIG. 34 illustrates a front, side, and top view of a cabled security device, in accordance with one embodiment;

FIG. 35 illustrates a perspective view of a cabled security device, in accordance with one embodiment;

FIG. 36 illustrates a front view of a cabled security device, in accordance with one embodiment;

FIG. 37 illustrates a top view of a cabled security device, in accordance with one embodiment;

FIG. 38 illustrates a side view of a cabled security device, in accordance with one embodiment;

FIG. 39 illustrates a partially internal perspective view of a cabled security device, in accordance with one embodiment;

FIG. 40 illustrates a partially internal top view of a cabled security device, in accordance with one embodiment;

FIG. 41 illustrates a partially internal perspective view of a cabled security device, in accordance with one embodiment;

FIG. 42 illustrates a partially internal side view of a cabled security device, in accordance with one embodiment;

FIG. 43 illustrates a perspective view of a cabled security device, in accordance with one embodiment;

FIG. 44 illustrates a perspective view of a cabled security device, in accordance with one embodiment;

FIG. 45 illustrates a perspective view of a cabled security device, in accordance with one embodiment;

FIG. 46 illustrates a perspective view of a cabled security device, in accordance with one embodiment;

FIG. 47 illustrates a front, side, and top view of a cabled security device, in accordance with one embodiment;

FIG. 48 illustrates a perspective view of a cabled security device, in accordance with one embodiment;

FIG. 49 illustrates a top view of a cabled security device, in accordance with one embodiment;

FIG. 50 illustrates a perspective view of a cabled security device, in accordance with one embodiment;

FIG. 51 illustrates a front view of a cabled security device, in accordance with one embodiment;

FIG. 52 illustrates a side view of a portion of a cabled security device, in accordance with one embodiment;

FIG. 53 illustrates a perspective view of a cabled security device, in accordance with one embodiment;

FIG. 54 illustrates a perspective view of a cabled security device, in accordance with one embodiment;

FIG. 55 illustrates a perspective view of a cabled security device, in accordance with one embodiment;

FIG. 56 illustrates a perspective view of a cabled security device, in accordance with one embodiment; and

FIG. 57 illustrates a front, side, and top view of a cabled security device, in accordance with one embodiment.

### DETAILED DESCRIPTION

Embodiments may be directed to apparatuses, systems and methods for pairing an article with a security tag.

For example, one embodiment may include a security device comprising a locking mechanism, security tag, and a housing. The locking mechanism may comprise a magnetically actuable latch, a flexible element that biases the magnetically actuable latch toward a locking position, and a latch mating element that mates with at least a portion of the magnetically actuable latch in the locking position. As used herein, the “locking position” may refer to the position of the magnetically actuable latch in which it is partially or fully within a void of, in engagement with, joined with, or otherwise mated with the latch mating element. The housing may be a structure configured to partially or fully contain, enclose, or otherwise secure the locking mechanism, security tag, latch mating element, and the article to the housing. As secured, the magnetically actuable latch of the locking mechanism may mate with the latch mating element in the locking position to lock the housing, and thus the security tag with which the housing is secured, to the article. When the housing is locked, the security device may prevent or provide resistance to an attempt to separate the housing from the article. Another embodiment may include a security system comprising the security device and a detacher, which may be a device that includes a magnet. The detacher may be employed to unlock the housing by magnetically forcing the magnetically actuable latch away from the locking position.

It is worthy to note that any reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Numerous specific details may be set forth herein to provide a thorough understanding of the embodiments. It will be understood by those skilled in the art, however, that the embodiments may be practiced without these specific details. In other instances, well-known methods, procedures and components have not been described in detail so as not to obscure the embodiments. It can be appreciated that the specific structural and functional details disclosed herein may be representative and do not necessarily limit the scope of the embodiments.

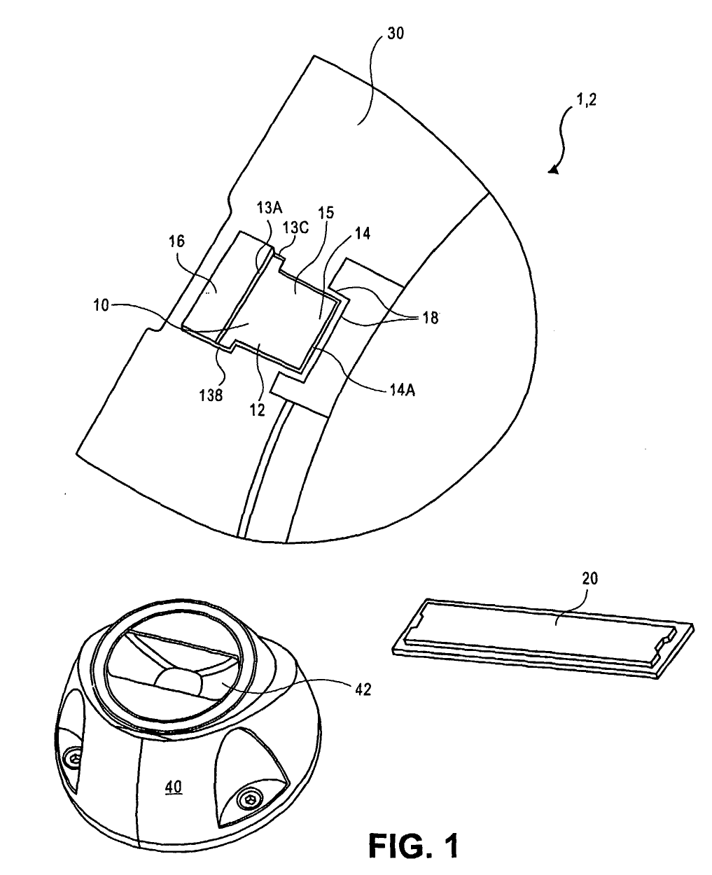

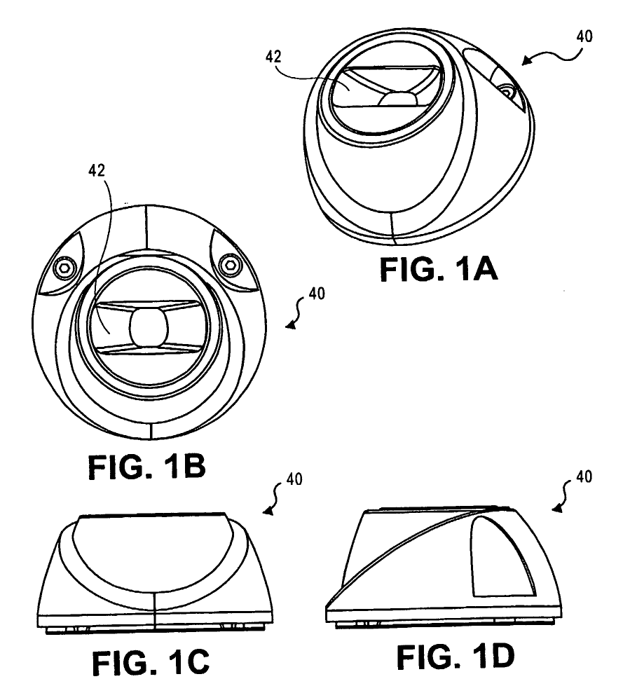

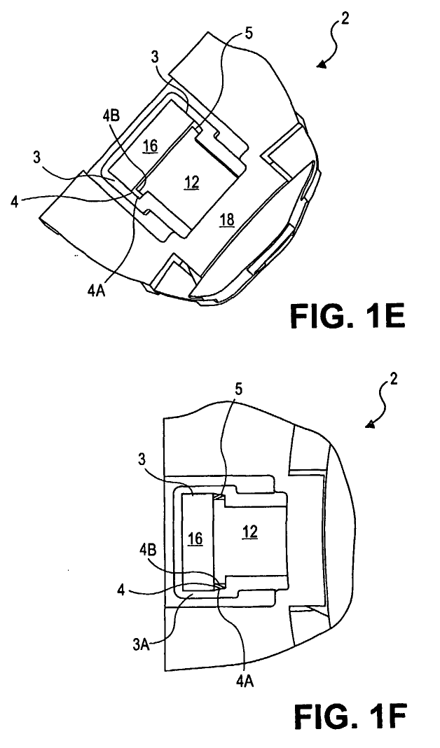

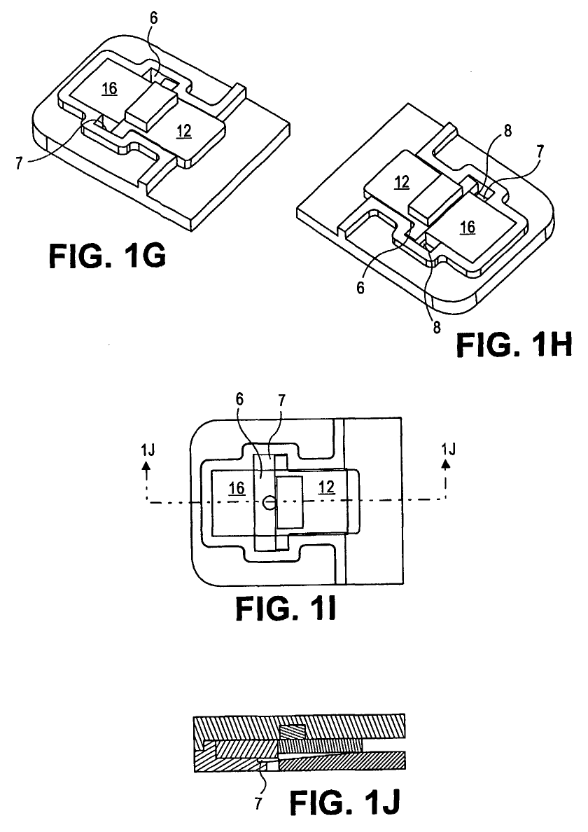

Referring now in detail to the drawings wherein like parts are designated by like reference numerals throughout, there is illustrated in FIG. 1 a front view of components that may be included in a security system 1 and a security device 2 in accordance with one embodiment. In this embodiment, the security system 1 includes the security device 2 and a detacher 40. The security device 2 may include a locking mechanism 10, security tag 20, and housing 30.

The locking mechanism 10 may be a magnetically actuable locking mechanism, and may include a magnetically actuable latch 12, flexible element 16, and latch mating element 18.

The magnetically actuable latch 12 may include a base portion 13, which may include a base portion end 13A and side surfaces 13B and 13C; and a latching portion 14, which may include a latching portion end 14A; and a central portion 15.

The magnetically actuable latch 12 may have a substantially rectangular-shaped face such that the base portion 13 has the same width as both the latching portion 14 and central portion 15. Thus, the width of the base portion 13, or the distance between the side surfaces 13B and 13C, may be the same as the corresponding widths of the latching portion 14 and central portion 15. In other embodiments, the widths of the base portion 13, latching portion 14, and central portion 15 may differ. The magnetically actuable latch 12 may have a slender, uniform cross-section.

However, the magnetically actuable latch 12 may be configured as desired, may comprise one or more pieces, and may be symmetrical or unsymmetrical about any point, line, or plane. For example, in various embodiments the magnetically actuable latch 12 may be configured with a “T”, “I”, curved, or other shape of face and with a rectangular, circular, thick, hollow or otherwise voided, and/or non-uniform cross-section, or as described herein with respect to various embodiments of the magnetically actuable latch 912. In another embodiment, the latching portion end 14A of the magnetically actuable latch 12 may include one or more teeth, ribs, notches, jags, points, curves, voids, or other shapes such as those described herein with respect to embodiment of the magnetically actuable latch 912, while the base portion end 13A may be flat or another shape. In addition, the base portion end 13A may be continuous or discontinuous. The magnetically actuable latch 12 may be configured such that at least a portion of it, such as the latching portion 14, may engage, receive, insert into, or otherwise mate with the latch mating element 18, such as described herein.

In one embodiment, a security device 2 includes multiple magnetically actuable latches 12, which may be disposed, possibly each along with another flexible element 16 and latch mating element 18, in the same or different portions of the security device 2. For example, in one embodiment, the multiple magnetically actuable latches 12 may each cooperate with another portion of the security device 2 to lock the portion, such as, for example, a portion securing an article or a portion securing a security tag 20.

The magnetically actuable latch 12 may comprise or may be formed of a magnetic material such as iron, nickel, or cobalt, or an alloy of iron, nickel, or cobalt. In one embodiment, the magnetically actuable latch 12 includes one or more magnetic materials and may also include one or more nonmagnetic materials.

The flexible element 16 may be shaped as desired, such as in a cuboid, ellipsoid, coil, or any other shape such as described herein with respect to the embodiments of the flexible element 916 and may include one or more pieces, or may be combined or integrally formed with the magnetically actuable latch 12. In one embodiment, the flexible element 16 may be shaped as a cantilever arm, such as, for example, a leaf spring. The flexible element 16 may comprise or may be formed of a flexible material such as a light, porous, semirigid, elastic, gaseous, and/or spongy material that may provide a resistant force when compressed and may partially or fully recover its uncompressed shape when the compressive force is removed. For example, in various embodiments, the flexible element 16 may comprise or may be formed of a foam rubber, polymeric foam, ceramic foam, or other foam; a rubber; and/or another material or materials. The flexible element 16 may also or alternatively be configured to provide the resistant force when compressed. For example, in various embodiments the flexible element 16 may be configured as a coil, leaf or other cantilevered arm, or other spring, or other like member, that comprises a metal, polymer, ceramic, and/or another material or materials. The flexible element 16 may have any of various masses.

The latch mating element 18 may be configured as desired, such as with one or more holes or other voids, ribs, teeth, protrusions, or other shapes. The latch mating element 18 may include one or more pieces, and may be separate from or integral with the housing 30, such as described herein. The latch mating element 18 may be configured to engage, receive, insert into, or otherwise mate with at least a portion of the magnetically actuable latch 12. For example, in an embodiment where the magnetically actuable latch 12 is a slender member with a rectangular shape of face, the latch mating element 18 may be configured with a void in which the latching portion 14 of the magnetically actuable latch 12 or a part thereof may be inserted into the locking position, as described herein. In an embodiment where the magnetically actuable latch 12 is toothed at its latching portion end 14A, the latch mating element 18 may be configured with ribs that engage the teeth in the locking position.

The security tag 20 may be any detectable device or system, such as any security tag or label. For example, in various embodiments the security tag 20 may be any type of EAS tag (e.g., Radio Frequency (RF) tag, acousto-magnetic tag, and/or combinations thereof), Radio Frequency Identification (RFID) tag, smart tag, or other detectable anti-theft or other tag. The security tag 20 may be detectable by a corresponding detecting system or device, such as, depending on the type of security tag or label, an acousto-magnetic detector, electromagnetic detector, radio frequency detector, or other detector.

The housing 30, as partially shown in the embodiment of FIG. 1, may be any casing or other structure that partially or fully contains and/or surrounds, encloses, affixes to, interlocks with, or otherwise secures the locking mechanism 10 and security tag 20, and, when the locking mechanism 10 is in the locking position and the housing is thereby locked, an article. The housing 30 and locking mechanism 10 may thus cooperate to secure, or lock, the article to the housing 30, and thus the security device 2. The housing 30 may be configured as desired, and may be shaped based upon the shapes of the locking mechanism 10, security tag 20, and article for which it is designed to secure, such as described herein with respect to the embodiments of the housings 930, 1030, 1130, and 1230. The housing 30 may include the latch mating element 18, which may be integral with the housing 30. The housing 30 may alternatively be configured to pair with the latch mating element 18. The housing 30 may comprise a polymer and/or another material or materials.

The components included in the security device 2 may be configured such that the security device 2 may lock to an article, such as described with respect to the security device embodiments below. The security tag 2 may be reusable or may be for one-time use.

FIGS. 1A-1D illustrate a perspective, top, front, and side view of the detacher 40 shown in FIG. 1, in accordance with one embodiment. The detacher 40 may be a device that includes and houses a magnet 42. The magnet 42 may be any type of magnet, such as any permanent magnet or electromagnet, for example. Regarding the security system 1, the detacher 40 may be employed with the security device 2 to unlock the security device 2 from an article. The detacher 40 may be positioned appropriately near the magnetically actuable latch 12 of the security device 2 to magnetically force the magnetically actuable latch 12 away from the locking position, thus allowing the housing 30 of the security device 2 to be removed from an article to which it may be locked.

In various embodiments, the detacher 40 may include different magnets 42. For example, the magnet 42 of the detacher 40 may be selected based upon the magnetic force needed to move the magnetically actuable latch 12 away from the locking position, thus unlocking the security device 2. This magnetic force may need to more than offset the forces opposing the movement. Such opposing forces may include, for example, the resistant force provided by the flexible element 16 when it is compressed by the magnetically actuable latch 12, frictional forces caused by the magnetically actuable latch 12 contacting the housing 30 and/or another element during movement, and other forces. In another embodiment, where a detacher 40 is intended to be used on various security devices having different configurations, a magnet 42 may be selected that is strong enough to unlock the security device requiring the strongest magnet to unlock it.

In one embodiment, the security device 2 may be configured for one-time use. For example, in one embodiment as shown in FIGS. 1E-1F, the magnetically actuable latch 12 of the security device 2 may be positioned within a channel 3 as mated with the latch mating element 18 in the locking position. One or more leaf springs or other cantilevered arms, such as the cantilevered arms 4 and 5, are disposed in the channel 3 in a spring-loaded configuration.

For example, the cantilevered arm 4 may have an unloaded position as shown in FIG. 1E. The cantilevered arm 4 may be bent to a position with its side 4A adjacent the channel wall 3A, and thus spring-loaded. The magnetically actuable latch 12 may then be disposed in the channel 3 in the locking position adjacent its other side 4B, preventing the cantilevered arm 4 from moving and preserving its spring load. The cantilevered arm 5 may be similarly positioned. Where the magnetically actuable latch 12 is then moved out of the locking position by the detacher 40, the cantilevered arms 4 and 5 may no longer be constrained by the magnetically actuable latch 12 and may spring back or otherwise return to their unloaded positions. Where in these positions the cantilevered arms 4 and 5 extend into the channel 3 such that they may block the base portion 13 of the magnetically actuable latch 12 from moving past them, the magnetically actuable latch 12 may not be able to return to the locking position. Thus, any appended security device may no longer be able to lock.

In another embodiment, only one of the cantilevered arms 4 and 5 is included. In various other embodiments, other resilient elements, such as coils or other springs, rubbers, and foams, for example, may be employed within the channel 3 or other portion of the housing to prevent the appended security device from being used twice.

In another embodiment such as shown in FIGS. 1G-1J, the locking mechanism portion and housing portion may be configured such that after each instance the magnetically actuable latch 12 is moved out of the locking position, the magnetically actuable latch 12 may need to be reset to enable it to be repositioned in the locking position. For example, the magnetically actuable latch 12 may be disposed in a channel 6 with its base end 13A adjacent a recess 7. The recess 7 may be configured such that where the magnetically actuable latch 12 is biased out of the locking position, at least a portion of the magnetically actuable latch 12 falls or is otherwise urged into the recess 7. The recess may be delineated by a wall 8 that may restrict movement of the magnetically actuable latch 12 back toward the locking position. In this embodiment, the security device in which the magnetically actuable latch 12 is disposed may be “reset” for use, such as by employing a magnet that may move the magnetically actuable latch 12 out of the recess.

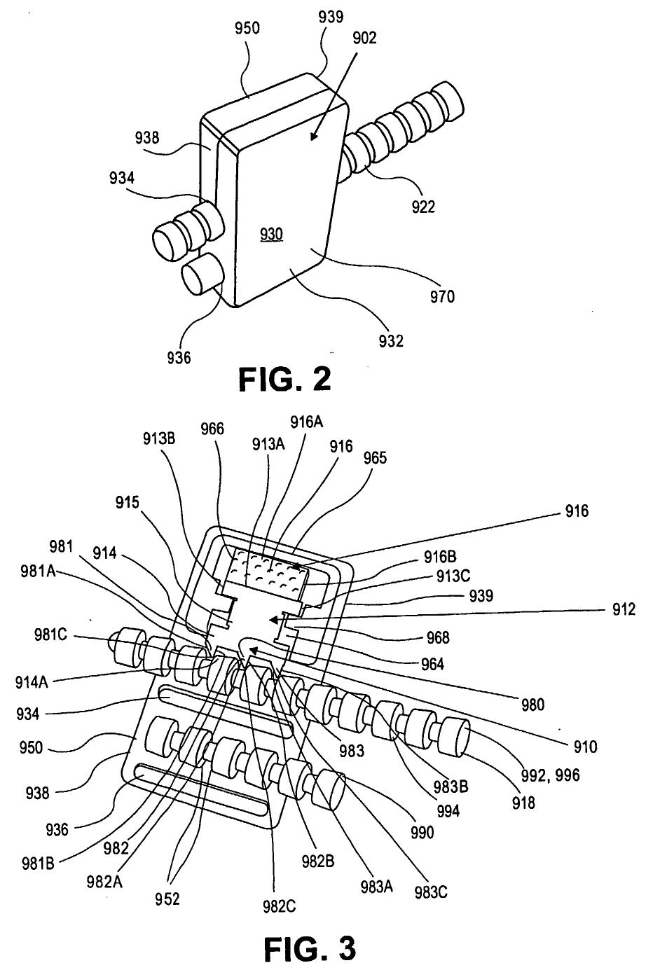

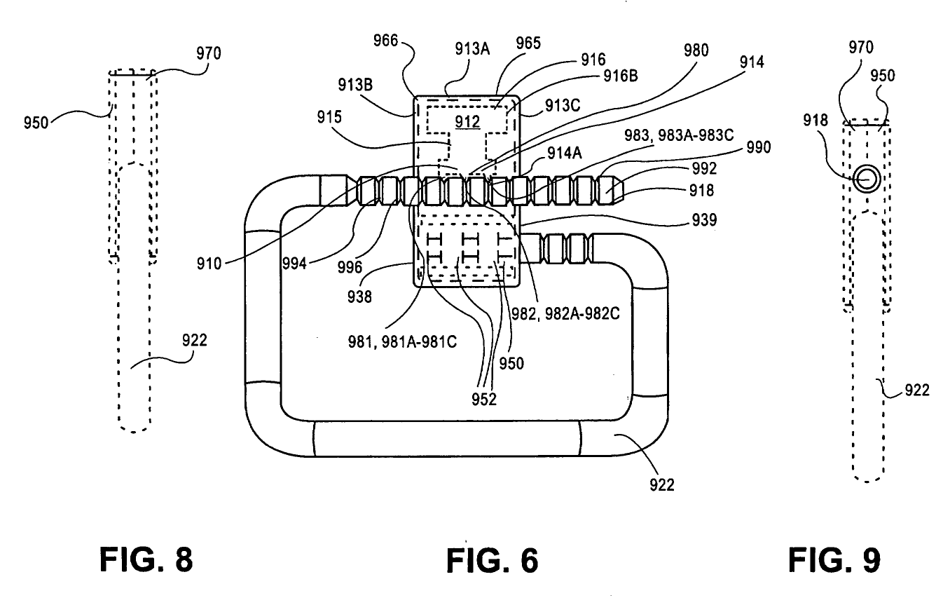

In another embodiment, a cabled security device 902, such as described with respect to the embodiments of FIGS. 2-9, may include a locking mechanism 910, a security tag 920, a cable 922, and a housing 930.

FIG. 2 illustrates a perspective view of a cabled security device 902, in accordance with one embodiment, and may be referred to where a corresponding element is discussed. The cabled security device 902 in this embodiment includes a housing 930, which may include a bottom housing 950 and a top housing 970, and a cable 922.

The cable 922 may be an elongate element and may be at least partially cylindrical, and may comprise a plastic and metal. The cable 922 may be flexible. However, in various embodiments, the cable 922 may have different configurations. For example, the cable 922 may include other shapes, another material or combination of materials, and/or one or more other elements of the cabled security device 902.

For example, in one embodiment, the cable 922 may be or be part of any of various sizes and shapes of closed loops. As used herein, the term “closed loop” may refer to a structure that continuously surrounds a void extending completely through the structure. The void may be considered to be part of the structure, or may be considered as space surrounded by the structure The void may or may not have a fixed size. The closed loop may be integral with another structure, such as a housing, or may be a separate piece. A closed loop may be formed for example, by coupling two portions of a continuous structure with each other or with a second structure that branches the two portions.

Closed loops may include, in various embodiments, lanyards, belts, cords, chains, straps, and other like structures each having continuous portions coupled with each other or with a branching structure. A closed loop may secure an article by being tightened around the article. A closed loop may secure an article thereto by extending through a void, the void extending through the article and being continuously surrounded by the article.

An example of an article that may be secured to a closed loop is a structure having a body and a continuous strap or other handle, the handle having at least a portion thereof that extends away from the body and has ends that are affixed, integral with, secured to, enclosed by, or otherwise coupled with the body such that the structure continuously surrounds a void extending through the article. Such a structure may be an article having a closed loop, such as a handbag, purse, or briefcase that has a strap or other continuous handle that is coupled with the article at two portions, such as ends.

A closed loop may secure an article thereto by being tightened around the article or a portion thereof.

As another example of a configuration of the cable 922, the cable 922 may be an elongate element that is at least partially cylindrical and includes the latch mating element 918, as described in an embodiment below.

The housing 930 may have an at least partially cuboidal outer shape, and may have a short “I” or short lowercase “l” shape to its outer face 932, or may have another shape. The housing 930 may include two apertures 934 and 936. Each of the apertures 934 and 936 may or may not extend through the sides 938 and 939 of the housing. The apertures 934 and 936 may each be at least partially cylindrical. However, in various embodiments, the apertures 934 and 936 may have another shape, such as at least a partially cuboidal or any other shape.

The apertures 934 and 936 may each be configured with a shape and size dependent upon the shape and size of the cable 922, which may, in various embodiments, extend into or through either or both apertures 934 and 936, such as described below.

The bottom housing 950 and top housing 970 of the housing 930 may be formed with part or all of one or both apertures 934 or 936. In one embodiment, the bottom and top housings 950 and 970 form part, such as half, for example, of the apertures 934 and 936 such that where the housing 930 is assembled, the bottom and top housings 950 and 970 cooperate to form the apertures 934 and 936. The housing 930, including the bottom housing 950 and top housing 970, may comprise one or more materials, such as plastics and metals, and the portions may comprise the same or different materials, or a combination thereof.

In various embodiments, the housing 930, and components thereof, may be configured and sized as desired, such as described with respect to the housing 30 of the FIG. 1 embodiment, for example.

FIG. 3 illustrates a perspective view of a portion of a cabled security device with a top housing removed, in accordance with one embodiment. FIG. 3 illustrates a perspective view of the locking mechanism 910 and bottom housing 950 of the cabled security device 902, in accordance with one embodiment. The locking mechanism 910 may include a magnetically actuable latch 912, flexible element 916, and a latch mating element 918.

The magnetically actuable latch 912 may comprise a magnetic material, and may comprise one or more materials, such as described with respect to the magnetically actuable latch 12 of FIG. 1. The magnetically actuable latch 912 may include a base portion 913, which may include a base portion end 913A and base portion side surfaces 913B and 913C; a latching portion 914, which may include a latching portion end 914A; and a central portion 915.

The magnetically actuable latch 912 may be shaped at least partially like an “I”. Thus, the base portion side surfaces 913B and 913C may be parallel and each may be at least substantially straight, and the width of the base portion 913, which may be the distance between base portion side surfaces 913B and 913C, may be wider than the corresponding width of the central portion 915 but similar to the corresponding width of the latching portion 914. The base portion end 913A may be flat and may be substantially perpendicular to the base portion side surfaces 913B and 913C. The magnetically actuable latch 912 may be configured with a slender thickness.

The magnetically actuable latch 912 may include one or more protrusions 980. The protrusions 980 may be positioned at least partially in the latch portion 914 of the magnetically actuable latch 912, and may have ends at the latching portion end 914A.

In one embodiment, the protrusions 980 may be one or more teeth, for example, three teeth 981-983. The three teeth 981-983 may have sides 981A-983A and 981B-983B that may be relatively angled such that they meet at, or terminate near, the tooth ends 981C-983C, respectively. The tooth ends 981C-983C may thus be pointed.

The sides 981A-983A may be at least substantially parallel, as may be the sides 981B-983B. The sides 981A-983A may be angled with respect to the base portion side surfaces 913A-913B of the base portion 913 and/or the one or both of the corresponding sides of the latching portion 914 and central portion 915 of the magnetically actuable latch 912. The sides 981B-983B may be substantially perpendicular or less angled (than the sides 981A-983A) with respect to the base portion side surfaces 913A-913B of the base portion 913 and the corresponding sides of the latching portion 914 and central portion 915. The teeth 981-983 may be equally spaced or non-uniformly spaced.

However, the one or more protrusions 980 may comprise other configurations. For example, the one or more protrusions 980 may comprise one or more ribs, notches, jags, points, curves, or voids, for example. The one or more protrusions 980 may be positioned at least partially on the latching portion 914 of the latch and may comprise the latching portion end 914A. The one or more protrusions 980 may be configured to mate with the latch mating element 918 in the locking position, such as described below.

The magnetically actuable latch 912 may be otherwise configured in various embodiments, such as described herein with respect to the magnetically actuable latch 12 shown in FIG. 1.

The flexible element 916 may comprise or be formed of a flexible material, and may include a material or materials such as described herein with respect to the flexible element 16 shown in FIG. 1. The flexible element 916, in one embodiment, may be configured with a substantially cuboidal shape such that its side 916A is wider than its side 916B, or may have another shape. In various other embodiments, the flexible element 916 may be configured as, and comprise one or more materials of, a coil or other spring or like member, such as described above with respect to the magnetically actuable latch 12 of FIG. 1.

The latch mating element 918 may be included in the cable 922, and may be separate from the housing 930. In this embodiment, the latch mating element 918 may include one or more voids 990. In one embodiment, the magnetically actuable latch 912 may mate with the latch mating element 918 in the locking position when the one or more teeth or other protrusions 980 extend into the one or more voids 990.

The one or more voids 990 may be delineated by one or more ribs 992, which may be protrusions such as described herein with respect to the protrusions 980. The one or more ribs 992 may each comprise rib sides 994 and 996, which may be non-parallel in one embodiment. For example, in one embodiment, the rib sides 994 may be substantially perpendicular or close to perpendicular to the tangential direction along the length of the latch mating element 918, whereas the rib sides 996 may have an angle that is that is acute, such as 45 degrees for example, relative to this length. Such a configuration may facilitate pulling or otherwise moving the latch mating element 918 through the aperture 934 in one direction but not the other, opposing direction, such as described below.

However, the latch mating element 918 may be otherwise configured, such as with one or more ribs, notches, jags, points, curves, or voids, for example, to mate with the magnetically actuable latch 912 in the locking position. For example, in one embodiment, the latch mating element 918 may be configured with one or more voids 990 shaped like or somewhat like that of the one or more protrusions 980 of the magnetically actuable latch 912. Thus, at least one void 990 may receive at least one protrusion 980 or a portion thereof, which may prevent or inhibit movement of the latch mating element 918 out of the aperture 934.

In another embodiment, the latch mating element 918 comprises a penetrable material such as rubber or a soft plastic, and the magnetically actuable latch 912 may include protrusions 980, such as pointed teeth. Such protrusions may dig into the latch mating element 918 where the magnetically actuable latch 912 is in the locking position and the latch mating element 918 is pulled with a force for directing it out of the aperture 934, and thus, the housing 930.

In one embodiment, the cable 922 includes the latch mating element 918, and may be variously configured. For example, the cable 922 and latch mating element 918 may include one or more materials. In one embodiment, the latch mating element 918 and cable 922 include plastic, which the one or more ribs 992 may comprise. The latch mating element 918 may also comprise a second material, such as stainless steel or another metal. This metal may form an internal portion of the latch mating element 918, and the plastic may be disposed around it. In various embodiments, the metal and plastic components may separable or inseparable. For example, the metal and plastic components may be bonded, press-fit, co-molded, inserted, and/or coated. The metal portion may strengthen the latch mating element 918 and prevent or inhibit breaking or otherwise separating portions of the latch mating element 918, and thus prevent or inhibit unlocking the cabled security device 902. The metal may be beaded, stranded, flat-wire, partially cylindrical, or may be formed in any suitable manner to reinforce the cable 922 so that the latch mating element 918 and cable 922 may be strengthened and still flexible. The plastic may be deformable such that the ribs 992 may deform when a compressive force is applied thereto.

In one embodiment, a cable 922 including a latch mating element 918 may be at least partially cylindrical and have a maximum diameter of ⅛ inch and comprise a plastic outer layer disposed around a 1/16 inch diameter stainless steel core. The ⅛ inch maximum diameter may comprise the maximum diameter of the latch mating element 918 at a rib 992. The diameter of areas of the latch mating element 918 at the voids 990 may be less than ⅛ inch, and may be more than 1/16 inch. In one embodiment, the diameter of areas of the latch mating element 918 having voids 990 are variable, and may vary between 1/16 inch and ⅛ inch, for example. In one embodiment, a portion of the cable 922 may not include the latch mating element and 918 and may have a uniform ⅛ inch diameter.

In various other embodiments, the latch mating element 918 may comprise other materials, such as soft rubber or other outer material and hard plastic or other inner material. In other embodiments, the cable 922 and latch mating element 918 may be formed of one or more materials that may or may not each form an inner or outer portion of the latch mating element 918.

The bottom housing 950 of the housing 930 may be configured such that the magnetically actuable latch 912 and flexible element 916 of the locking mechanism 910 may be adjacently disposed therein. Thus, the base portion end 913A of the magnetically actuable latch 912 may be positioned near or in abutment with the flexible element 916. With such a configuration, the movement of the magnetically actuable latch 912 and flexible element 916 may be restricted in one or more directions.

For example, the bottom housing 950 may include a channel end wall 965, channel walls 966 and 968, and a channel 964 delineated by channel walls 966 and 968 and bounded by the channel end wall 965. The channel walls 966 and 968 may include portions substantially parallel to each other, and may be positioned close to or in contact with the magnetically actuable latch 912 at the base portion side surfaces 913B and 913C and at the sides of the central and latching portions 915 and 914, respectively, thereby restricting the movement of the magnetically actuable latch 912 to movement along the channel 964, which may be movement in a substantially linear direction, for example.

In various other embodiments, the magnetically actuable latch 912 may move in a rotational, combination rotational/linear direction, or any other direction or directions. In these various other embodiments, one or more of the channel 964, flexible element 916, and latch mating element 918 may be contoured, shaped, or otherwise configured to guide the magnetically actuable latch 912 in the direction or directions.

The flexible element 916 may be positioned adjacent the channel end wall 965 such that where the magnetically actuable latch 912 is forced away from the locking position and against the flexible element 916, the flexible element 916 may compress by the force of the magnetically actuable latch 912 and the resistant force of the channel end wall 965. The flexible element 916 may provide a resistant force to such compression, against such movement of the magnetically actuable latch 912.

As described above, in each of various embodiments the magnetically actuable latch 912 may be configured with another shape, in which case the channel 964, and thus the channel walls 966 and 968, may be configured to accommodate such a magnetically actuable latch 912 and possibly restrict the movement of the magnetically actuable latch 912 in one or more directions. In each of these embodiments, the flexible element 916 may be configured to fit within the channel 964.

Thus, the flexible element 916 of the locking mechanism 910 may bias the magnetically actuable latch 912 into the locking position where the teeth 918-983 or other protrusions 980 of the magnetically actuable latch 912 may engage the ribs 992 of the latch mating element 918 portion disposed in the aperture 934 of the housing 930. Such a configuration may prevent or provide resistance to movement of the latch mating element 918 out of the aperture 934 and thus the housing 930.

For example, in one embodiment, where a tooth 981 of the magnetically actuable latch 912 is disposed in the locking position between two ribs 992, the adjacent rib side 994 may be substantially parallel or have a small angle relative to the tooth side 981B. But the rib side 994 and tooth side 981B may be substantially perpendicular or close to perpendicular to the direction in which the latch mating element 918 moves through the aperture 934 as constrained by the walls of the aperture 934. Thus, where a force is applied to the latch mating element 918 to pull it out of the aperture 934, the latch mating element 918 may move until the rib side 994 and tooth side 981B contact and exert opposing substantially or close to normal forces on each other. In such case, the latch mating element 918 may be prevented or inhibited from being pulled out of the aperture 934.

However, in one embodiment, such a configuration may not prevent or may provide less resistance to movement of the latch mating element 918 into the aperture 934 of the housing 930. Thus, the tooth side 981A and adjacent rib side 996 may be angled relative to the direction of movement of the latch mating element 918 in the aperture 934. Where a force is applied to the latch mating element 918 to pull it further into the aperture 934, the latch mating element 918 may move until the rib side 996 and tooth side 981A contact. In such case, the rib side 996 and tooth side 981A may exert much lower opposing normal forces, and if the outer material of the latch mating element 918 is deformable as discussed herein, the latch mating element 918 may be moved. Movement may be made by a force greater than any normal force, friction force caused by the rib side 996 and tooth side 981A sliding against each other, compressive force the rib 992 provides from its deformation, and/or any other opposing forces.

This force to move more of the latch mating element 918 into, and possibly through, the aperture 934 (such as to feed the cable 922 extending from the aperture 936 into the aperture 934 in the direction shown, e.g., in FIG. 2) may be lower, and may be much lower, than the force to move the latch mating element 918 out of the aperture. Thus, for example, this lower force may be manageably exerted, in one embodiment, by a person such that the person may tighten the latch mating element 918 (which may be secured at its other end in the aperture 936 as discussed herein) around an article. In embodiments where the magnetically actuable latch 912 has multiple protrusions 980 and the latch mating element 918 has multiple ribs 992, the opposing forces caused by all protrusions 980 and ribs 992 in contact may need to be overcome. This force may still be such that a person can manageably force the latch mating element 918 further into the aperture 934.

Additionally, since the cable 922 may extend out of the aperture 934 and then into the aperture 936 of the housing 930, where it may also be secured, as discussed below, the continuous cable 922 may form a closed loop that includes the cable 922 and the housing 930 branching portions thereof. Thus, the magnetically actuable latch 912, along with the bottom housing 950 and top housing 970, may cooperate as assembled to prevent or provide resistance to opening the closed loop, may secured an article to the cabled security device 902, to remove the article.

The bottom housing 950 of the housing 930 may be further or alternatively configured to receive the top housing 970.

Referring again to FIG. 1, the top housing 970 may have an outer shape and interior configuration such that it may be disposed on the bottom housing 950 to enclose the magnetically actuable latch 912 and flexible element 916 of the locking mechanism 910 within the cabled security device 902. For example, the top housing 950 and bottom housing 970 may be shaped as half or another portion of the housing 930 to configure the housing 930 as described above.

One or both of the bottom housing 950 and top housing 970 may include, within the aperture 936, one or more recesses. Each recess may be shaped to contain a part of the cable 922, such as a rib 992, and to cooperate with other portions of the housing 930 to secure the cable 922 thereto, such as at one of its ends. In one embodiment, the bottom housing 950 includes one or more recesses 952, such as three, that are each shaped to receive a rib 992. The top housing 970 may be positioned closely adjacent each rib 992 when disposed on the housing 950 to secure each rib 992 within a recess 952. As such, each rib 992 may be blocked from moving out of the one or more recesses, and the end or other portion of the cable 922 may thereby be secured to the cabled security device 902.

In another embodiment, the aperture 936 portion at or near the side 939 may be sized to receive an area of the cable 922 between two ribs 992, but may be too small to fit a rib 992 through. Thus, the aperture 936 portion at or near the side 939 may surround an area of the cable 922 between two ribs 992 such that one rib 992 is disposed in the housing 930. The housing may thereby secure the cable 922.

The housing 930, as assembled, may also secure a second portion of the cable 922 within the aperture 934. Since the cable 922 may thus be branched by the housing 930 and be continuous, the cabled security device 930 may comprise a closed loop. Since cable 922 may be secured to the housing 930 as such as described herein, the closed loop may be formed as part of the cabled security device 902.

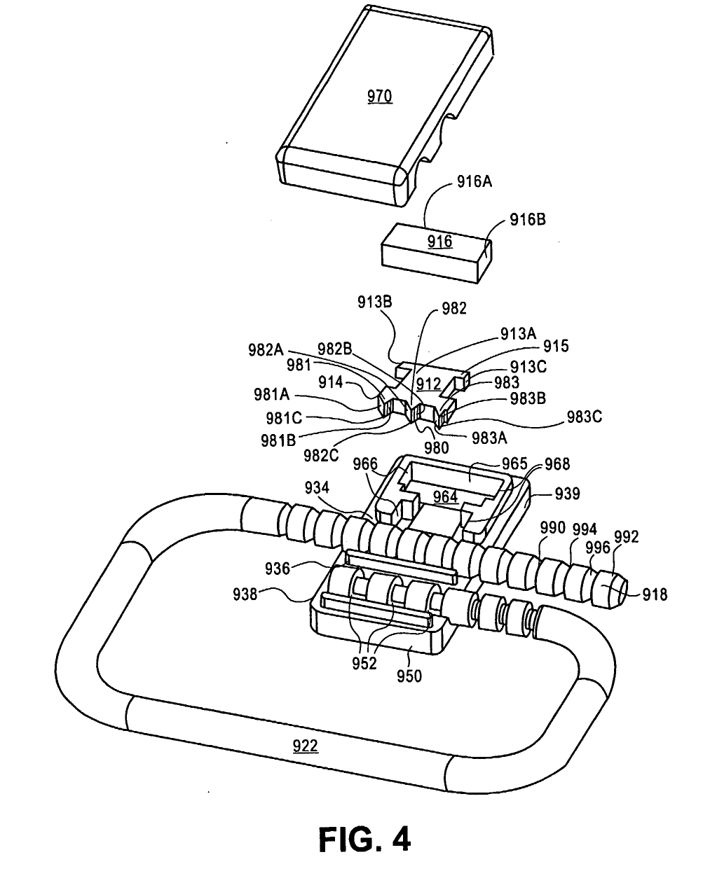

FIG. 4 illustrates an exploded view of elements that may be included in the cabled security device 902, such as described above in FIGS. 2-3, in accordance with one embodiment.

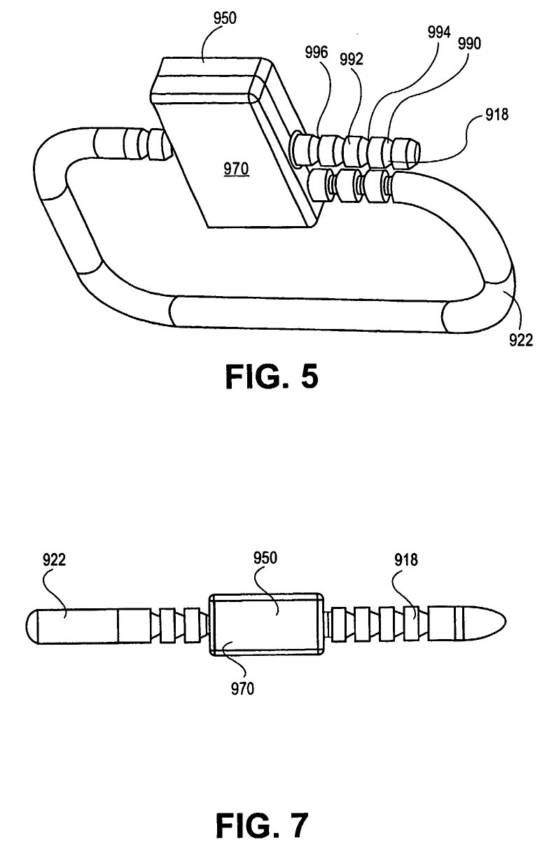

FIGS. 5-9 illustrates a top, front, side, and side view, respectively, of the cabled security device 902, such as described above with respect to FIGS. 2-3, in accordance with one embodiment.

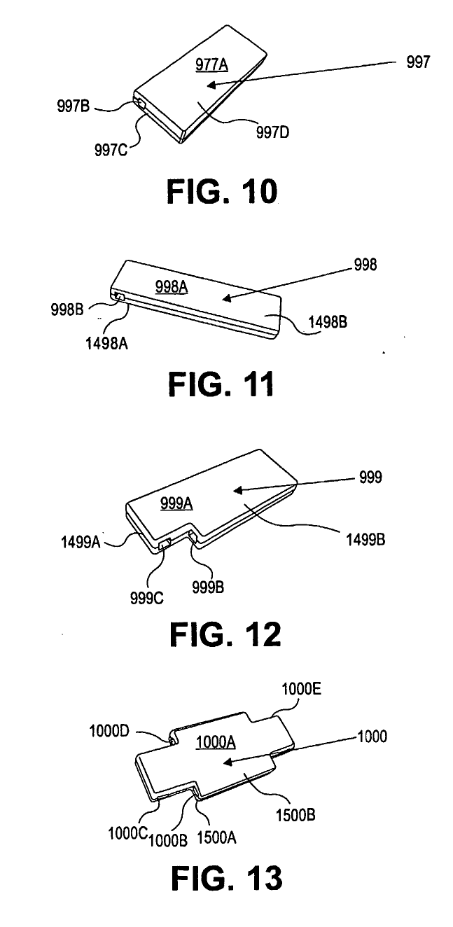

FIG. 10 illustrates a perspective view of a security tag assembly 997, in accordance with one embodiment. The security tag assembly 997 may include a security tag housing 997A enclosing a security tag, such as the security tag 20 of FIG. 1, for example. The security tag housing may include an aperture 997B that extends through the security tag housing 997 adjacent its long side. The aperture 997B may be configured with a size and shape such that the cable 922 may extend through it. Thus, where the cabled security device 902 is assembled, the security tag assembly 997 may be secured to the cable 997, and thus the security tag it encloses may be secured to the housing 930. Such a configuration may thus allow for the security tag assembly 997 to be variously positioned on the cable 922 and thus variously positioned with respect to the housing 930.

Such a configuration may also allow for multiple security tag assemblies 997 to be positioned on the cable 997 to provide multiple security tags, such as security tags 20, to be secured to the housing 930. For example, in one embodiment, a security tag assembly 997 enclosing an EAS tag and a security tag assembly 997 enclosing an RFID may be secured to the cable 922 and thus to the housing 930 to which the cable 922 is secured. In another embodiment, any combination of EAS tags, RFID tags, Ultramax tags, smart tags and other detectable anti-theft or other tags may be enclosed in security tag assemblies 997, which may each be secured to the cable 922 and thus the housing.

The security tag housing 997A may include a bottom housing 997C and a top housing 997D, each of which may be shaped to be disposed on the other.

The bottom housing 997C and top housing 997D may be secured together by welding, fusing, gluing, snap-fit (such as where the bottom housing 997C and top housing 997D are configured with mating protrusions and voids, for example), interference fit, and/or by other securing means. Such securing means may prevent or provide resistance to separation of the bottom housing 997C and top housing 997D, and thus removal of the security tag therein.

FIGS. 11-13 illustrate perspective views of other embodiments of security tag assemblies 998-1000, respectively. These security tag assemblies 998-1000 may also have security tag housings 998A-1000A including bottom housings 1498A-1500A and top housings 1498B-1500B, respectively, with security tags enclosed therein, but may include differently-positioned apertures. Thus, the security tag housings 998A-1000A may be variously positioned relative to cables 998 that may extend through them.

For example, the aperture 998B may extend through the security tag housing 998 adjacent its short side. The apertures 999B and 999C may extend through the security tag housing 999 adjacent its long and short side respectively, to enable two possible positions relative to a cable 922 extending through it. The apertures 1000B-1000E may extend adjacent four sides to enable four possible such relative positions.

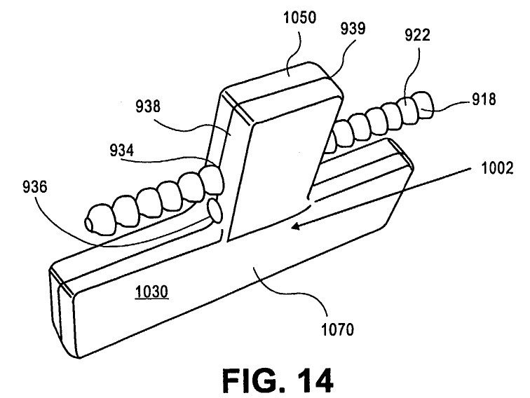

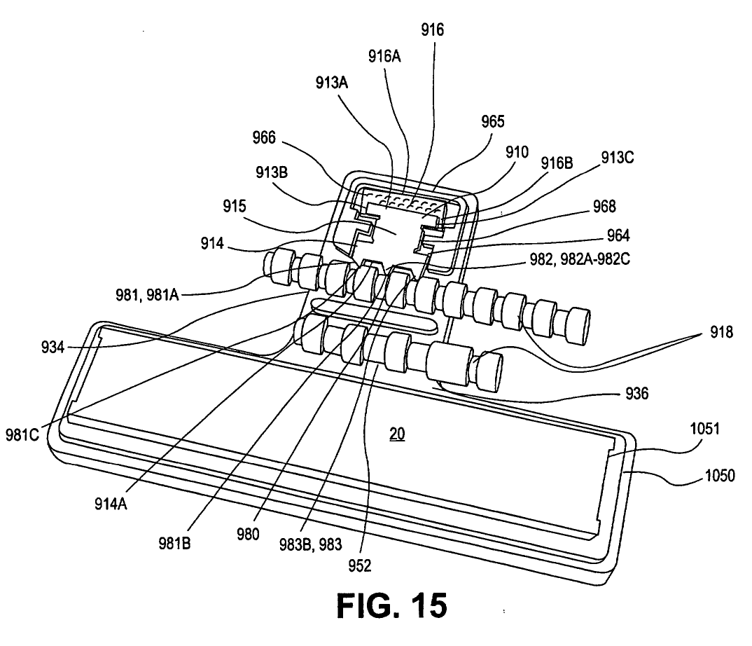

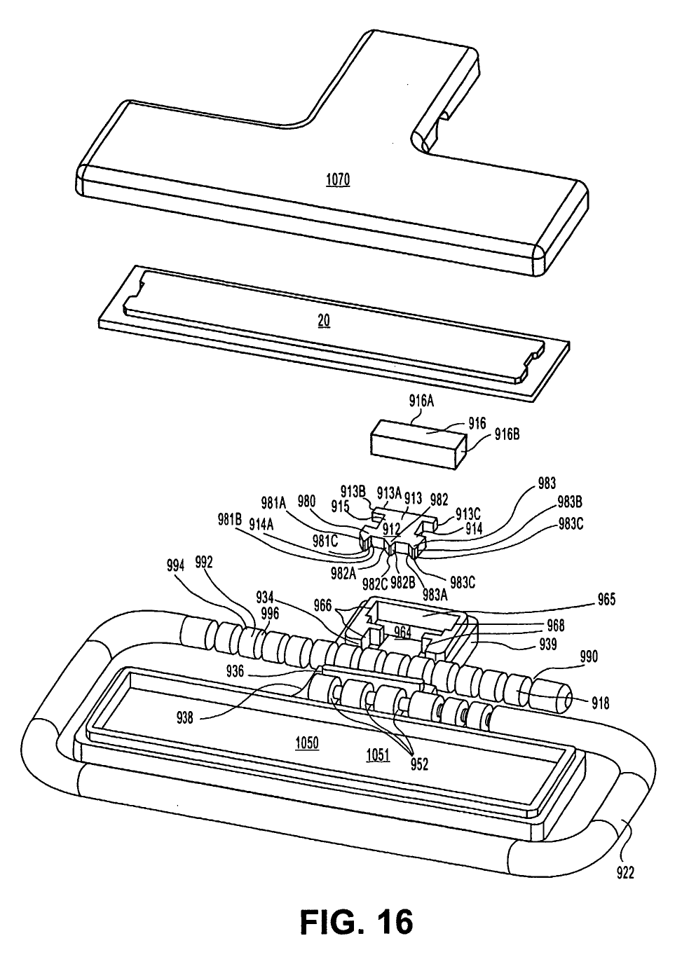

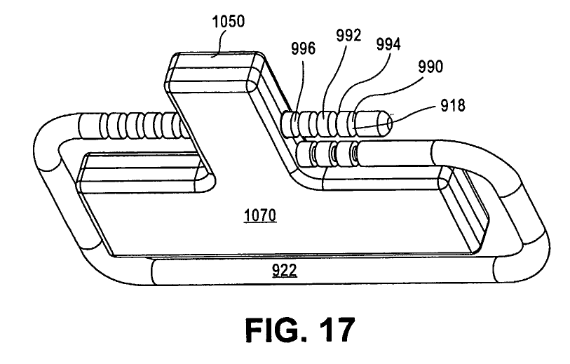

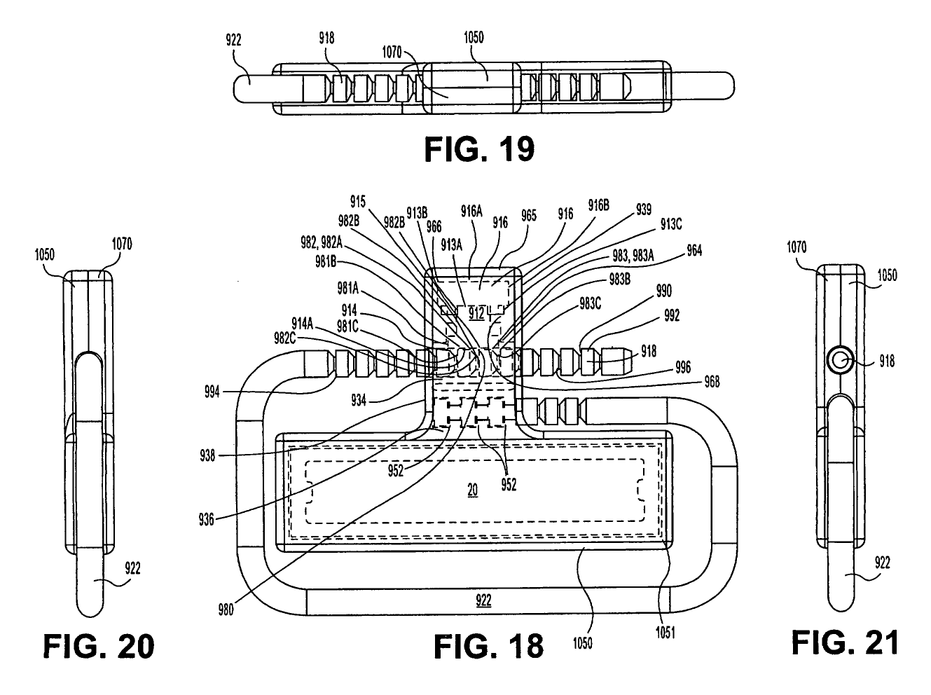

FIGS. 14-21 illustrate various views of a cabled security device 1002 or portion thereof, in accordance with one embodiment. The cabled security device 1002 may include elements such as those described with respect to the cabled security device 902 of FIGS. 2-9 and referenced in FIGS. 14-21. However, the cabled security device 1002 may have a housing 1030 comprising a bottom housing 1050 that also includes a tag compartment 1051 configured to receive a security tag 20, and a top housing 1070 shaped to be disposed on the bottom housing 1050. The bottom and top housings 1050 and 1070 may be configured with a “T” shape. Where the security device 1002 is assembled, the security tag 20 may be disposed in the tag compartment 1061 and thus be secured by the cabled security device 1002.

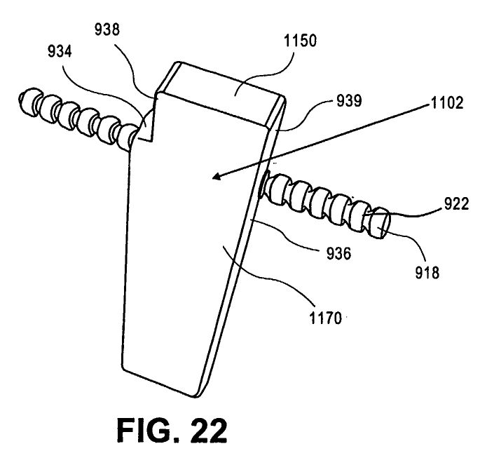

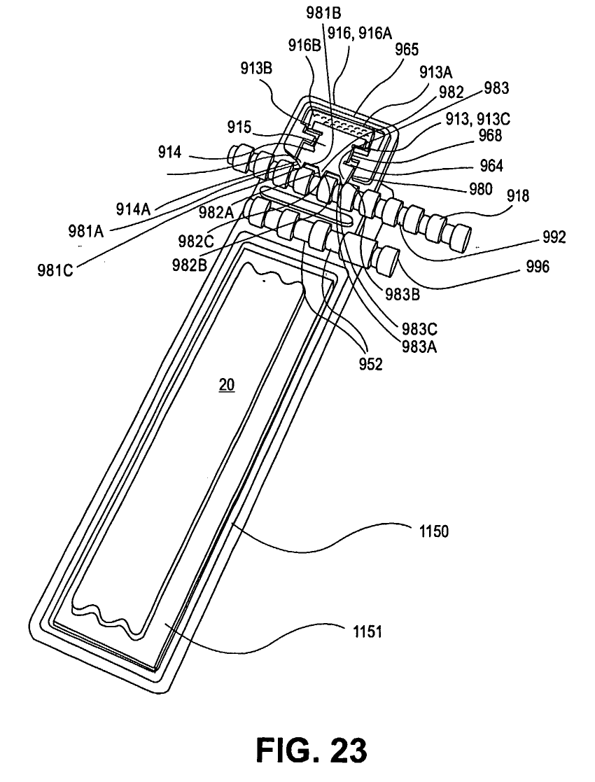

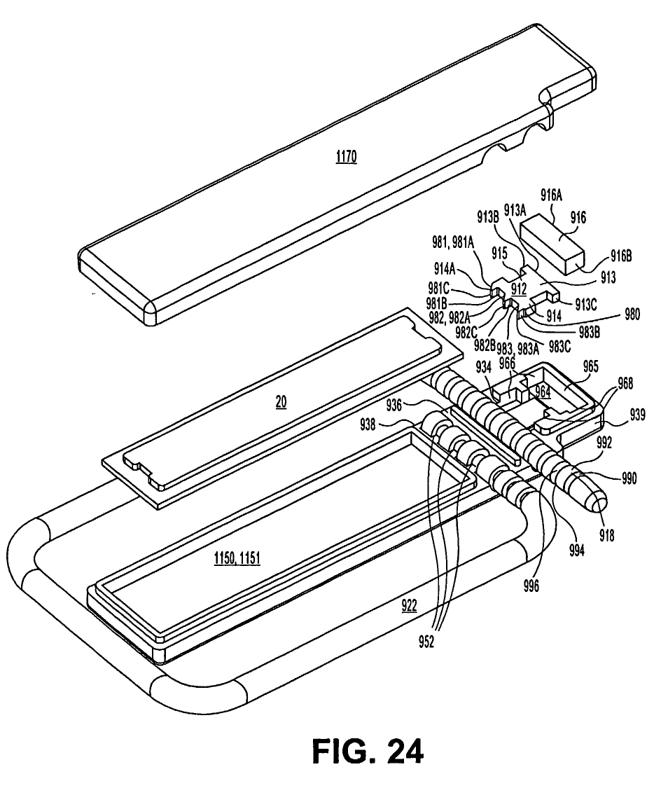

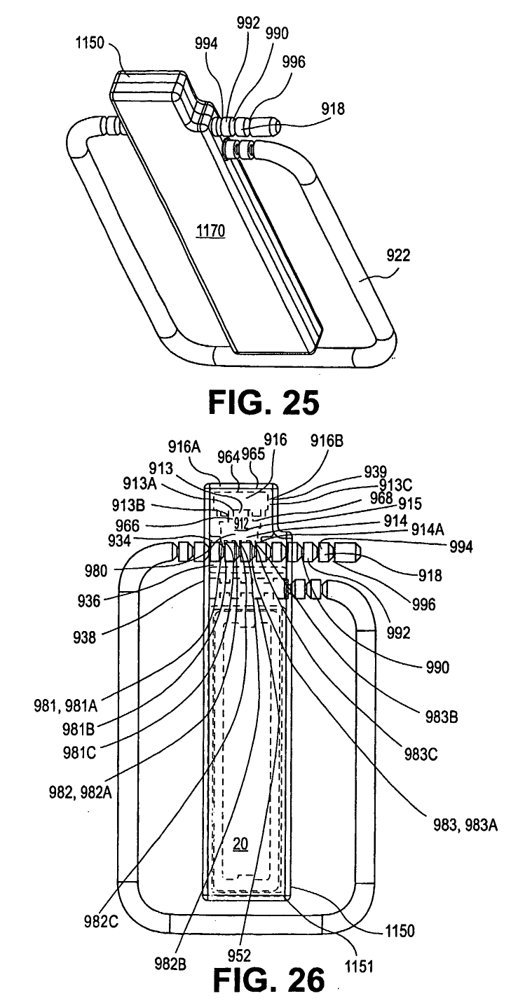

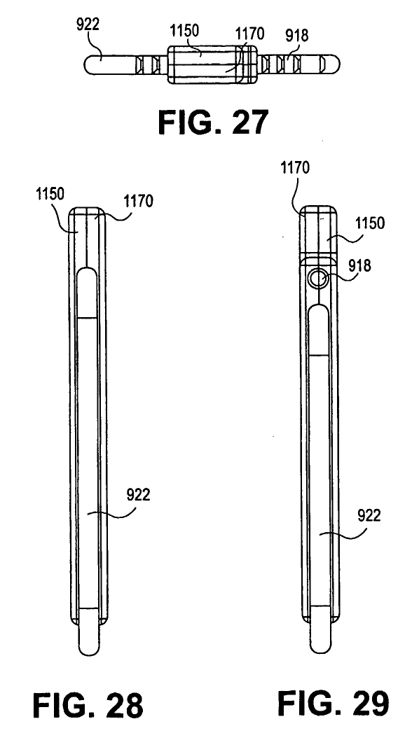

FIGS. 22-29 illustrate various views of a cabled security device 1102 or portion thereof, in accordance with one embodiment. The cabled security device 1102 may include elements such as those described with respect to the cabled security device 902 of FIGS. 2-9 and referenced in FIGS. 22-29. However, the cabled security device 1102 may have a housing 1130 comprising a bottom housing 1150 that also includes a tag compartment 1151 configured to receive a security tag 20, and a top housing 1170 shaped to be disposed on the bottom housing 1050. The bottom and top housings 1150 and 1170 may be configured with a long “I” or long lower-case “l” shape. Where the security device 1002 is assembled, the security tag 20 may be disposed in the tag compartment 1061 and thus be secured by the cabled security device 1102.

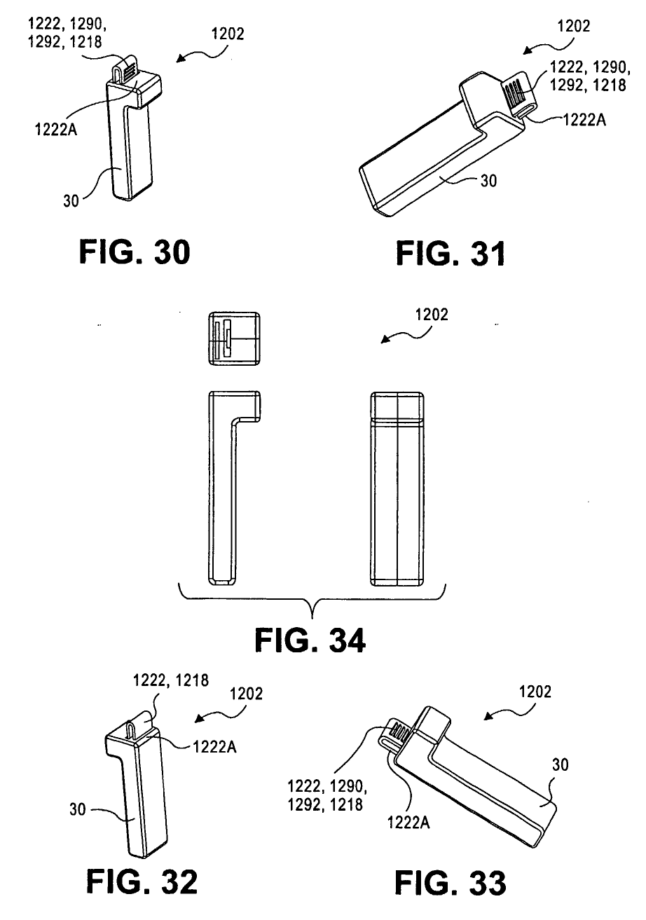

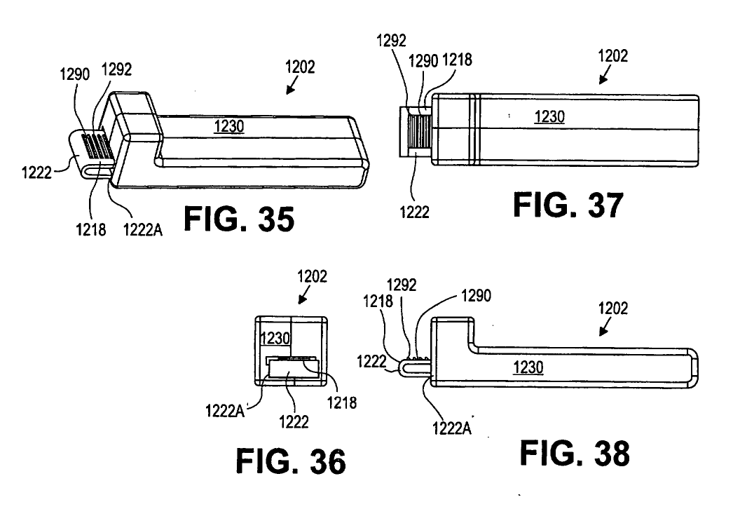

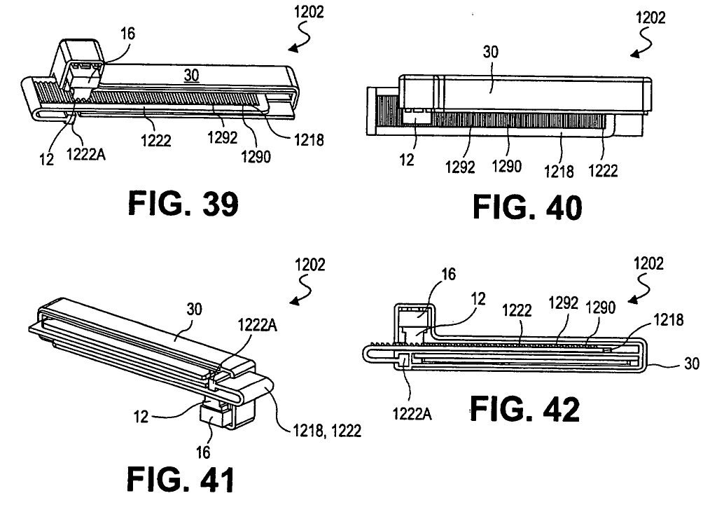

FIGS. 30-42 illustrate various views of a cabled security device 1202 or portion thereof, in accordance with one embodiment. The cabled security device 1202 may include elements such as those described with respect to the cabled security device 1102 of FIGS. 22-29, and may be shaped at least partially like an “I” and to enclose a security tag in its housing. However, in this embodiment the cabled security device 1202 includes a cable 1222 that may be flexible and shaped as a strap or ribbon. The cable 1222 may include a latch mating element 1218 having one or more voids 1290 and protrusions 1292 that may be disposed on a flat surface. The cable 1222 may be secured at one end 1222A in the housing 30, and may extend from the end 1222A. The cable 1222, as configured as a strap, may facilitate tightening the cable 1222 around at article.

The cabled security device 1202 of the embodiment of FIGS. 30-42 may be configured such that the cable 1222 is secured at either end within the housing 1230 of the cabled security device 1202. Thus, the cable 1222 in this embodiment may not extend into the housing 1230 and then back out such that one end of the cable 1222 may dangle from the housing 1230. Thus, the cabled security device 30 may secure the cable 1222 such that the cable 1222 has no free end.

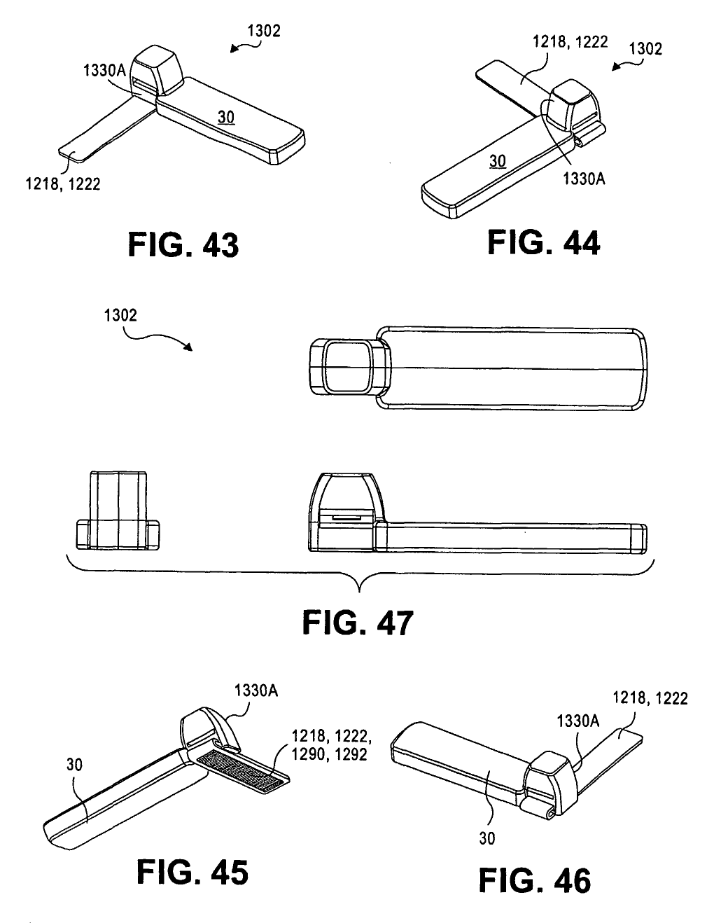

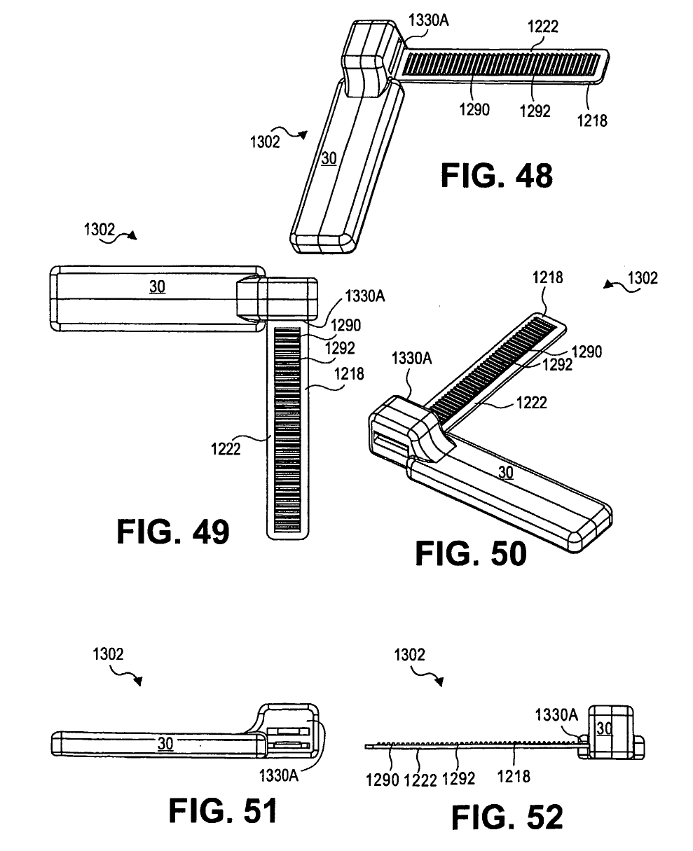

FIGS. 43-52 illustrate various views of a cabled security device 1302 or portion thereof, in accordance with one embodiment. The cabled security device 1302 may be configured similar to the cabled security device 1202 shown in FIGS. 30-42, but may cable 1222 secured on a side 1330A of the housing 30.

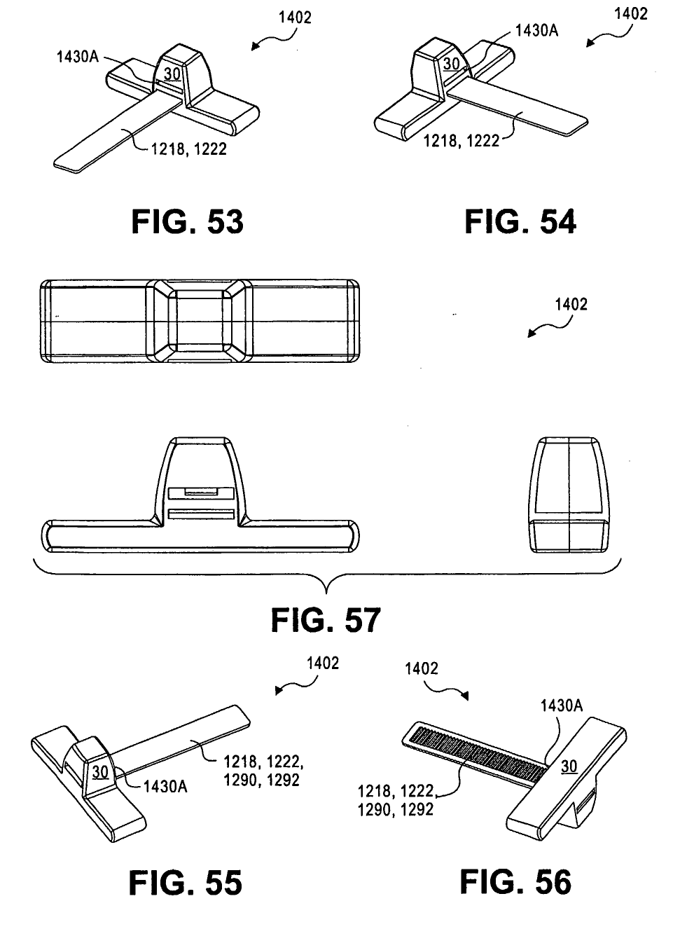

FIGS. 53-57 illustrate various views of a cabled security device 1402 or portion thereof, in accordance with one embodiment. The cabled security device 1402 may also be configured similar to the cabled security device 1202, but may cable 1222 secured on a central 1430A of the housing 30.

In each of various embodiments, one of the cables 1222, 1322, and 1422 may be substituted for one of the cables 902, 1002, or 1102 described herein, and vice versa.

In each of various embodiments, one of the cabled security devices 902, 1002, 1102, 1202, 1302, and 1402 may comprise more than one cable and possibly also more than one magnetic locking mechanism or portion thereof, such as a magnetically actuable latch. For example, the cabled security device 902 may be configured with a second locking mechanism 910 and second cable 922 that operate similarly to the first ones. In various embodiments, the cabled security device 902 may be configured such that the cables 922 extend out the opposite, same, or adjacent sides of the housing 930.

In each of various embodiments, a cabled security device system includes any of the cabled security devices 902, 1002, 1102, 1202, 1302, and 1402 described herein with respect to FIGS. 2-57 and a detacher, such as the detacher 40 described herein with respect to FIG. 1. For example, with respect to the cabled security device 902 embodiment, where the detacher 40 is placed near the magnetically actuable latch 912 of the cabled security device 902 such that the flexible element 916 is positioned between the detacher 40 and magnetically actuable latch 912, the detacher 40 may magnetically force the magnetically actuable latch 912 out of the locking position and against the flexible element 916. If the magnetic force is greater than the compressive force of the flexible element 916 and any other forces resisting such movement of the magnetically actuable latch 912, the magnetically actuable latch 912 may move out of the locking position. In such case, the cable 922 may not be blocked from moving completely out of the aperture 934 and out of the cabled security device 902.

In various embodiments, because no part of each of the security devices 902, 1002, 1102, 1202, 1302, and 1402 may be broken to unlock it, that security device may be reusable. In another embodiment, that security device employs a magnetically actuable latch that is for one-time use or is resettable.

In each of various other embodiments, a security device 902, 1002, 1102, 1202, 1302, or 1402 may be capable of holding an EAS tag and a magnetic mechanism. This security device may, in one embodiment, carry an EAS component and may be utilized to provide resistance to or prevent the unauthorized from taking and then leaving a store with the security device and any article that may be partially enclosed or otherwise secured thereto.

In one embodiment, a cabled security device 902 may have a “short I” configuration and include a bottom housing 950, top housing 970, and a locking mechanism 910 that may be called a latch mechanism. The cabled security device 902 may include a security tag or label housed, such as the security tag 20 described herein with respect to FIG. 1, in one of the following four holders: an EAS Label 2 sides cable entrance, EAS Label 4 sides cable entrance, EAS Label short cable entrance, and EAS Label long cable entrance, which may correspond to the security tag assemblies 997-1000 of FIGS. 10-13, respectively. In an embodiment, the holders for a security tag or label may include a top and a bottom housing and an EAS label, which may correspond to the security tag assemblies 997-1000 including a top housing, 997C and 1498A-1500A and a bottom housing 997D and 1498B-1500B and a security tag, such as the security tag 20.

In one embodiment, a cabled security device 1002 may have a “T” configuration and include a bottom housing 1050, top housing 1070, a locking mechanism 910 that may be called a latch mechanism, and a security tag, such as the security tag 20.

In one embodiment, a cabled security device 1102 may have a “Long I” configuration and include a bottom housing 1150, top housing 1170, a locking mechanism 910 that may be called a latch mechanism, and a security tag, such as the security tag 20.

While certain features of the embodiments have been illustrated as described herein, many modifications, substitutions, changes and equivalents will now occur to those skilled in the art. It is, therefore, to be understood that the appended claims are intended to cover all such modifications and changes as fall within the scope of the embodiments.

1. A security device for an article, comprising:
a magnetically actuable locking mechanism;
a cable; and
a housing, the magnetically actuable locking mechanism and cable secured to the housing.

2. The security device of claim 1, wherein the magnetically actuable locking mechanism comprises a magnetically actuable latch, a flexible element, and a latch mating element.

3. The security device of claim 2, wherein the flexible element and the magnetically actuable latch are combined as a single piece.

4. The security device of claim 1, further comprising a second cable, the second cable secured to the housing.

5. The security device of claim 1, further comprising a second magnetically actuable locking mechanism.

6. The security device of claim 2, wherein the magnetically actuable latch mates with the cable in a locking position, and wherein the security device further comprises a second cable and a second magnetically actuable locking mechanism that comprises a second magnetically actuable latch, the second magnetically actuable latch mating with the second cable in a second locking position.

7. The security device of claim 2, wherein the housing further comprises a channel, and wherein the magnetically actuable latch and flexible element are at least partially disposed in the channel.

8. The security device of claim 2, wherein the cable comprises the latch mating element.

9. The security device of claim 2, wherein the latch mating element comprises at least one void.

10. The security device of claim 9, wherein the flexible element is positioned adjacent the magnetically actuable latch and biases the magnetically actuable latch toward a locking position in which at least part of the magnetically actuable latch extends into the void.

11. The security device of claim 2, wherein the latch mating element comprises at least one rib.

12. The security device of claim 11, wherein the at least one rib mates with the magnetically actuable latch when the magnetically actuable latch is in the locking position.

13. The security device of claim 2, wherein the magnetically actuable latch includes at least one protrusion to mate with the latch mating element.

14. The security device of claim 13 wherein the latch mating element comprises at least one void, and wherein the at least one protrusion is to mate with the latch mating element by mating with the at least one void.

15. The security device of claim 2, wherein the latch mating element comprises a penetrable material.

16. The security device of claim 2, wherein the magnetically actuable latch is positioned between the flexible element and the latch mating element.

17. The security device of claim 1, further comprising a security tag.

18. The security device of claim 17, wherein the security tag is enclosed within the housing.

19. The security device of claim 17, further comprising a security tag housing to secure to the cable, the security tag housing enclosing the security tag.

20. The security device of claim 1, wherein the cable is a strap.

21. The security device of claim 1, wherein the cable comprises a metal interior and a plastic exterior.

22. The security device of claim 21, wherein the cable is reinforced.

23. The security tag of claim 21, wherein the metal is beaded.

24. The security tag of claim 21, wherein the metal is stranded.

25. The security tag of claim 1, wherein the article comprises a closed loop, and wherein the cable secures the closed loop to the housing.

26. The locking mechanism of claim 1, wherein the magnetically actuable latch may be moved away from the locking position by magnetic force.

27. The locking mechanism of claim 26, wherein the magnetically actuable latch may be moved in a substantially linear direction.

28. The locking mechanism of claim 26, wherein the magnetically actuable latch may be moved in a substantially rotational direction.

29. The locking mechanism of claim 26, wherein the magnetically actuable latch may be moved in a combination of a rotational and linear direction.

30. The security tag of claim 1, wherein the cable and housing together comprise a closed loop.

31. The security device of claim 1, wherein the security device is reusable.

32. The security device of claim 1, wherein the security device is for one-time use.

33. The security device of claim 1, wherein the security device is resettable.

34. The security device of claim 10, wherein when the magnetically actuable latch is in the locking position, resistance is provided against the moving of the cable in one direction relative to an opposing direction.

35. A security device system for an article, comprising:
a security device comprising a housing, a cable secured to the housing, and a magnetically actuable locking mechanism disposed in the housing; and
a detacher to unlock the security device, the detacher comprising a magnet.

36. A security device for an article, comprising:
a security tag;
a magnetically actuable locking mechanism;
a cable; and
a housing, the cable and housing comprising means for forming a closed loop to secure the article.

37. The security device of claim 36, wherein the housing further comprises means for securing the security tag.

38. The security device of claim 36, further comprising means for securing the security tag to the cable.
